(19) United States
(12) Patent Application Publication
(10) Pub. No.: US 2010/0196686 A1
(43) Pub. Date: Aug. 5, 2010

(54) POROUS FACING MATERIAL, ACOUSTICALLY ATTENUATING COMPOSITE, AND METHODS OF MAKING AND USING THE SAME

(76) Inventor: Gerald L. Van Dam, New Richmond, WI (US)

Correspondence Address: 3M INNOVATIVE PROPERTIES COMPANY, PO BOX 33427, ST. PAUL, MN, 55133-3427, US

(21) Appl. No.: 12/669,698

(22) PCT Filed: Jun. 25, 2008
(86) PCT No.: PCT/US08/68127

§ 371 Date: Jan. 19, 2010

Related U.S. Application Data
(60) Provisional application No. 60/952,697, filed on Jul. 30, 2007.

(51) Int. Cl. D04H 1/42; B32B 5/24; B32B 5/18; D04H 1/56; D04H 3/16; B60R 13/08; G10K 11/168; B32B 37/00

(52) U.S. Cl. 428/219; 156/60; 428/311.51; 264/109; 264/119; 264/6; 156/221

(57) ABSTRACT

A porous facing material comprises a nonwoven web containing interfused thermoplastic elastomeric fibers. The interfused thermoplastic elastomeric fibers comprise a blend of at least two thermoplastic elastomers of a different tensile modulus. The nonwoven web has a basis weight in a range of from 100 to 1500 grams per square meter and a thickness of from 0.2 to 3.5 millimeters, and is abrasion resistant. Acoustically attenuating composites, which have an airflow resistance of from 100 to 10000 mks rayls, and which include a porous facing material secured to a porous backing, are also disclosed. Methods of making and using the foregoing articles are also disclosed.

### BACKGROUND

The term “facing material” refers to a material used to conceal and/or protect structural and/or functional elements from an observer. Common examples of facing materials include upholstery and wall coverings (including stationary and/or movable wall coverings and cubicle wall coverings). Facing materials typically provide a degree of aesthetic appearance and/or feel, but they may also provide a degree of physical protection to the elements that they conceal. In some applications, it is desirable that the facing material provide properties such as, for example, aesthetic appeal (for example, visual appearance and/or feel) and abrasion resistance.

Facing materials widely are used in motor vehicle construction. In the automotive industry, it is common practice to refer to various surfaces as being A-, B-, or C-surfaces.

As used herein, the term “A-surface” refers to a very high visibility surface of a motor vehicle that is most important to the observer or that is most obvious to the direct line of vision (for example, see A-surfaces 310 shown in FIG. 3). Examples include surfaces generally above waist level of an average person. With respect to motor vehicle interiors examples include dashboards, instrument panels, steering wheels, head rests, upper seat portions, headliners, and pillar coverings.

As used herein, the term “B-surface” (for example, see B-surfaces 320 shown in FIG. 3) refers to a high visibility surface of a motor vehicle that is visible but is not as obvious to the direct line of vision as an “A-surface”. B-surfaces are usually adjacent to an A-surface. Examples include surfaces partially covered by the hood or trunk of a motor vehicle and surfaces of vehicle interiors generally below waist level of an average seated person.

As used herein, the term “C-surface” (for example, see C-surfaces 330 shown in FIG. 3) refers to surfaces of a vehicle that are hidden in the installed position. Examples include back surfaces of upholstery and headliners.

### SUMMARY

In one aspect, the present invention provides a porous facing material having first and second opposed major surfaces and comprising a nonwoven web, wherein the nonwoven web comprises interfused thermoplastic elastomeric fibers, wherein the interfused thermoplastic elastomeric fibers comprise a blend of at least first and second thermoplastic elastomers, wherein at 300 percent elongation the first thermoplastic elastomer has a first tensile modulus and the second thermoplastic elastomer has a second tensile modulus that is at least 8.2 megapascals greater than the first tensile modulus, wherein the nonwoven web has a basis weight in a range of from 100 to 1500 grams per square meter and a thickness of from 0.2 to 3.5 millimeters, and wherein, if tested, at least one of the first or second surfaces of the porous facing material passes at least 30 wear cycles of the Taber Abrasion Test described herein.

In some embodiments, if tested, at least one of the first or second surfaces of the porous facing material passes at least 200, 4000, or even at least 10000 wear cycles of the Taber Abrasion Test described herein. In some embodiments, the porous facing material has an airflow resistance in a range of from 100 to 10000 mks rayls. In some embodiments, for at least a portion of the porous facing material, the first major surface is substantially smoother than the opposed second major surface. In some embodiments, at least a portion of the first major surface has a predetermined texture. In some embodiments, the porous facing material has a cross-web breaking force of at least 50 newtons per one inch (2.54 cm) width and a corresponding elongation at break of at least 150 percent. In some embodiments, the porous facing material has a solidity of at least 0.35. In some embodiments, the porous facing material has a rate of moisture vapor transmission according to ASTM E96/E96M-05, “Standard Test Methods for Water Vapor Transmission of Materials” (2005), using the Procedure for Water Method (upright dish) of at least 600 grams per square meter per 24 hours. In some embodiments, the porous facing material is thermoformed. In some embodiments, the nonwoven web consists essentially of the interfused thermoplastic elastomeric fibers. In some embodiments, the first and second thermoplastic elastomers are present in a respective weight ratio of from 20:80 to 80:20. In some embodiments, the first and second thermoplastic elastomers comprise aliphatic polyurethanes. In some embodiments, the porous facing material further comprises at least one of a stain repellent or a light stabilizer.

In general, the porous material has a substantially uniform consistency on an area basis, although consistency may vary through the thickness of the material; for example, the consistency of a calendered surface will typically vary relative to the interior of the porous facing material.

Porous facing material according to the present invention is useful, for example, in motor vehicle passenger compartments, where its combination of physical properties (for example, breaking force and elongation at break, moisture vapor transport, flexibility, and abrasion resistance), aesthetic (for example, tactile and/or visual), and processibility (for example, thermoformability) allow it to be readily used in a wide variety of components. Accordingly, in another aspect, the present invention provides a motor vehicle interior component comprising a porous facing material according to the present invention, wherein the first major surface comprises an A-surface or a B-surface.

Porous facing material according to the present invention is useful, for example, in the manufacture of acoustically attenuating composites. Accordingly, in another aspect, the present invention provides an acoustically attenuating composite comprising a porous facing material according to the present invention; and a porous backing secured to the second major surface of the porous facing material, wherein the acoustically attenuating composite has an airflow resistance in a range of from 100 to 10000 mks rayls.

In yet another aspect, the present invention provides an acoustically attenuating composite comprising:

a porous facing material having first and second opposed major surfaces and comprising a nonwoven web, wherein the nonwoven web comprises interfused thermoplastic elastomeric fibers, has a basis weight in a range of from greater than 250 to 1500 grams per square meter and has a thickness of from 0.2 to 3.5 millimeters; and

a porous backing secured to the second major surface of the nonwoven web, wherein the acoustically attenuating composite has an airflow resistance of from 100 to 10000 mks rayls.

In some embodiments, the first major surface is substantially smoother than the opposed second major surface. In some embodiments, at least a portion of the first major surface has a predetermined texture. In some embodiments, if tested, at least one of the first or second surfaces of the porous facing material passes at least 30 wear cycles of the Taber Abrasion Test described herein. In some embodiments, the porous facing material has a cross-web breaking force of at least 50 newtons per one inch (2.54 cm) width and a corresponding elongation at break of at least 150 percent. In some embodiments, the porous facing material has a solidity of at least 0.35. In some embodiments, the porous facing material has a rate of moisture vapor transmission according to ASTM E96/E96M-05, “Standard Test Methods for Water Vapor Transmission of Materials” (2005), using the Procedure for Water Method (upright dish) of at least 600 grams per square meter per 24 hours. In some embodiments, the porous facing material is thermoformed. In some embodiments, the nonwoven web consists essentially of the interfused thermoplastic elastomeric fibers. In some embodiments, the interfused thermoplastic elastomeric fibers comprise first and second thermoplastic elastomers that are present in a respective weight ratio of from 20:80 to 80:20. In some embodiments, the first and second thermoplastic elastomers comprise aliphatic polyurethanes. In some embodiments, the nonwoven web further comprises at least one of a stain repellent or a light stabilizer.

Acoustically attenuating composites according to the present invention are useful, for example, in motor vehicle passenger compartments and/or as upholstery or an architectural covering. Accordingly, in another aspect, the present invention provides a motor vehicle interior component comprising an acoustically attenuating composite according to the present invention, wherein the first major surface comprises an A-surface or a B-surface.

In some embodiments, motor vehicle interior components according to the present invention are selected from the group consisting of door panels, head rests, arm rests, dashboards, headliners, seats, floor coverings, rear window decks, steering wheels, visors, pillar surfaces, consoles, and trunk liners.

In yet another aspect, the present invention provides a method of making a porous facing material, the method comprising:

forming fibers of molten thermoplastic elastomeric material wherein the thermoplastic elastomeric material comprises a combination of at least first and second thermoplastic elastomers, wherein at 300 percent elongation the first thermoplastic elastomer has a first tensile modulus and the second thermoplastic elastomer has a second tensile modulus that is at least 8.2 megapascals greater than the first tensile modulus; and

collecting the fibers of molten thermoplastic elastomeric material under conditions such that the fibers of molten thermoplastic elastomeric material interfuse and solidify to form a nonwoven web having first and second major surfaces, a basis weight in a range of from 100 to 1500 grams per square meter, and a thickness of from 0.2 to 3.5 millimeters, and wherein, if tested, at least one of the first or second surfaces of the porous facing material passes at least 30 wear cycles of the Taber Abrasion Test described herein.

In some embodiments, the porous facing material has an airflow resistance in a range of from 100 to 10000 mks rayls. In some embodiments, the method further comprises calendering the porous facing material. In some embodiments, the method further comprises imparting a predetermined texture to at least a portion of a first major surface of the porous facing material. In some embodiments, the porous facing material has a cross-web breaking force of at least 50 newtons per one inch (2.54 cm) width and a corresponding elongation at break of at least 150 percent. In some embodiments, the method further comprises thermoforming the porous facing material. In some embodiments, the first and second thermoplastic elastomers are present in a respective weight ratio of from 20:80 to 80:20. In some embodiments, the fibers of molten thermoplastic elastomeric material are formed by a meltblown process.

In yet another aspect, the present invention provides a method of making an acoustically attenuating composite, the method comprising:

providing a porous facing material having first and second opposed major surfaces and comprising a nonwoven web of interfused thermoplastic elastomeric fibers and, wherein the porous facing material has a basis weight in a range of from greater than 250 to 1500 grams per square meter and a thickness of from 0.2 to 3.5 millimeters; and

securing the facing material to the porous backing of the second major surface of the nonwoven web such that the acoustically attenuating composite has an airflow resistance of from 100 to 10000 mks rayls.

In some embodiments, the method further comprises calendering a nonwoven web (for example, between calender rolls). In some embodiments, the method further comprises imparting a predetermined texture to at least a portion of the first major surface of the nonwoven web. In some embodiments, at least a portion of the porous facing material passes at least 30 wear cycles of the Taber Abrasion Test described herein.

In some embodiments, the porous facing material has a cross-web breaking force of at least 50 newtons per one inch (2.54 cm) width and a corresponding elongation at break of at least 150 percent. In some embodiments, the porous facing material has a solidity of at least 0.35. In some embodiments, the porous facing material has a rate of moisture vapor transmission according to ASTM E96/E96M-05, “Standard Test Methods for Water Vapor Transmission of Materials” (2005), using the Procedure for Water Method (upright dish) of at least 600 grams per square meter per 24 hours. In some embodiments, the method further comprises thermoforming the nonwoven web.

As used herein:

the term “airflow resistance” refers to airflow resistance determined according to ASTM C 522-03, “Standard Test Method for Airflow Resistance of Acoustical Materials” (2003);

the term “interfused thermoplastic elastomeric fibers” refers to thermoplastic elastomeric fibers that are bonded one to another while at least partially in a molten state;

the term “porous facing material” means a nonwoven web that is intrinsically capable of transmitting air through its thickness without resort to adding perforations, slits, or the like;

the term “blend” as it refers to thermoplastic elastomers means an intimate mixture of thermoplastic elastomers, and which may be homogenous or inhomogeneous;

the term “cross-web” as applied to a nonwoven web refers to the direction, generally within the plane of the nonwoven, if appropriate, that is perpendicular to the machine direction of the nonwoven web;

the term “cross-web breaking force” refers to the force required to break a web measured along the cross-web direction;

the term “cross-web” as applied to a nonwoven web refers to the direction, generally within the plane of the nonwoven, that is perpendicular to the machine direction;

the term “elastomer” means an elastic polymer

the term “machine direction” as applied to a nonwoven web refers to that direction corresponding to the direction of travel during manufacture of the nonwoven web;

the term “tensile modulus” refers to the ratio of stress to elastic strain in tension (for example, at an elongation of 100 percent or 300 percent);

the terms “thermoformed” and “thermoforming” refer to a manufacturing process wherein a thermoplastic nonwoven web, sheet, or film is heated to its forming temperature and stretched over or into a temperature-controlled mold then held against the mold surface(s) until cooled; and

the term “thickness” refers to the thickness if placed between flat platens under a pressure 0.013 psi (90 Pa).

### Taber Abrasion Test:

The abrasion resistance of the material to be tested is evaluated using a rotary platform, double-head abrader identical or equivalent to that available under the trade designation “TABER ABRASION TESTER” from Taber Industries, North Tonawanda, N.Y. At least one specimen of the material to be evaluated is separately mounted on adhesive coated cardboard stock identical or equivalent to that available from Taber Industries under the trade designation “S-36 Specimen Mounting Card”, and which is securely mounted on the abrader and subjected to continuous wear cycles using HR-22 wheels and a 1000 gram (1 kg) load per wheel until there is wear through (that is, readily visible hole(s) or tearing of the sample). A specimen is considered to have passed this test if there is no wear-through or tearing of the specimen.

### BRIEF DESCRIPTION OF THE DRAWINGS

FIG. 1 is a cross-sectional schematic view of an exemplary porous facing material according to one aspect of the present invention;

FIG. 2 is a cross-sectional schematic view of an exemplary acoustically attenuating composite according to one aspect of the present invention; and

FIG. 3 is a cutaway perspective schematic view of an exemplary motor vehicle interior including facing material and acoustically attenuating composites accordingly to aspects of the present invention.

### DETAILED DESCRIPTION

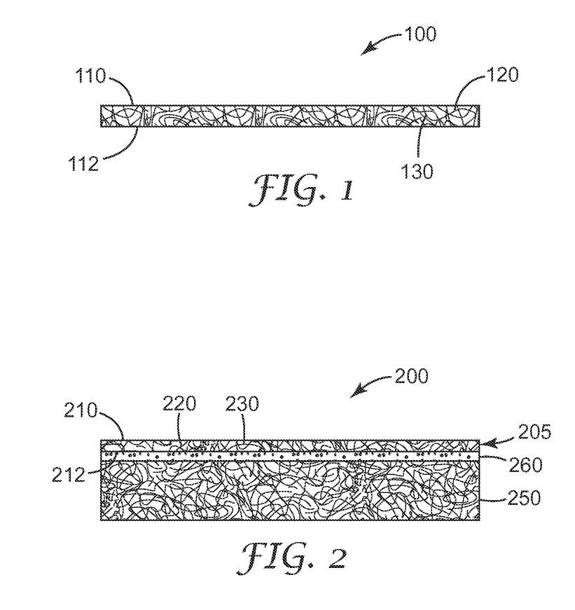

FIG. 1 shows an exemplary porous facing material 100 according to one aspect of the present invention. Porous facing material 100 has first and second opposed major surfaces 110, 112 and comprises nonwoven web 120 which comprises interfused thermoplastic elastomeric fibers 130. Interfused thermoplastic elastomeric fibers 130 comprise a blend of at least first and second thermoplastic elastomers 140, 142 (not shown).

Porous facing materials according to and/or used in practice of the present invention comprise a nonwoven web of interfused thermoplastic elastomeric fibers and generally comprise at least one thermoplastic elastomer. For example, nonwoven webs may comprise a single thermoplastic elastomer or a combination (for example, a blend) of two or more thermoplastic elastomers. Examples of suitable thermoplastic elastomers include styrene-based thermoplastic elastomers (for example, styrene-butadiene copolymers and styrene-isoprene copolymers), olefin-based thermoplastic elastomers (for example, chloroprene rubbers, ethylene/propylene rubbers, butyl rubbers, polybutadienes, polyisoprenes, EPDM polymer), ionomeric thermoplastic elastomers, vinyl chloride-based thermoplastic elastomers, polyurethane-based thermoplastic elastomers, and polyamide-based thermoplastic elastomers, alloys of the foregoing, blends of the foregoing, and combinations thereof. Thermoplastic elastomers comprising a combination of one or more thermoplastic(s) and rubber(s) may also be used. A wide variety of the foregoing materials are known to those of ordinary skill in the art, and commercial sources are abundant. For example, suitable commercial thermoplastic elastomers include: those marketed under the trade designation “KRATON D SIS” (styrene-isoprene-styrene) by Kraton Polymers, Houston, Tex.; those marketed under the trade designations “RTP 1500 SERIES” (polyether-ester block copolymer thermoplastic elastomer), “RTP 2700 SERIES” (styrenic block copolymer elastomer), “RTP 2800 Series” (thermoplastic polyolefin elastomer,), and “RTP 2900 Series” (polyether-block-amide thermoplastic elastomer) by RTP Co., Winona, Minn.; and those marketed under the trade designations “DYNAFLEX”, “VERSAFLEX”, “VERSALLOY”, and “VERSOLLAN” by GLS Corporation, McHenry, Ill.

The elastomeric fibers may desirably comprise at least first and second thermoplastic elastomers. In such cases, any weight ratio of the first and second thermoplastic elastomers may be used. For example, a respective weight ratio of first and second thermoplastic elastomers in a range of from 20:80 to 80:20 or from 30:70 to 70:30 is typically desirable.

Of the foregoing, polyurethane-based thermoplastic elastomers (for example, aromatic polyurethane-based thermoplastic elastomers and/or aliphatic polyurethane-based thermoplastic elastomers) are found to be particularly useful for forming the nonwoven webs used in practice of the present invention. Examples of polyurethane-based thermoplastic elastomers include aromatic and aliphatic thermoplastic elastomeric polyurethanes. Commercially available thermoplastic polyurethane elastomers include, for example, those available under the trade designations: “PELLETHANE” from Dow Chemical Co., Midland, Mich.; “ELLASTOLAN” from BASF Corp., Florham Park, N.J.; “MULTI-FLEX” from Multibase, Copley, Ohio; “ESTANE” and “TECO-FLEX” from Lubrizol Corp., Wickliffe, Ohio; “TEXIN” and “DESMOPAN” from Bayer Corp., Pittsburgh, Pa. For those applications requiring good weathering performance and/or color stability, aliphatic polyurethane thermoplastic elastomers are typically used.

Optionally, additives such as, for example, one or more stain repellent, antioxidant, and/or light stabilizer (for example, a UV absorber or a hindered amine light stabilizer) may be incorporated into the nonwoven web. For example, such optional components may be mixed into the thermoplastic elastomers during extrusion or by spraying them onto an already formed nonwoven web. Examples of useful stain repellents include fluoropolymer melt additives and topical treatments such as for example those available under the trade designation “SCOTCHGARD” from 3M Co., St. Paul, Minn. If two or more thermoplastic elastomers are used they may be combined within the same fibers or relegated to different fibers. Moreover, if two or more thermoplastic elastomers are used, they may desirably be selected such that they have different physical properties. For example, the tensile modulus of the thermoplastic elastomers may differ from one another by at least 8.2 megapascals (1200 psi), at least 10.4 megapascals (1500 psi), or even at least 13.8 megapascals (2000 psi).

Nonwoven webs may be made by any suitable technique such as, for example, by a meltblown process (for example, resulting in a meltblown web) or a meltspun process (for example, resulting in a spunbond web). Spunbond webs generally comprise meltspun fibers that are cooled, drawn, collected on a forming surface in a random isotropic manner as a loosely entangled web. Meltblown webs are formed by extruding molten thermoplastic polymer through a row of orifices in a die into a high-velocity air stream, where the extruded polymer streams are attenuated into generally fine-diameter fibers (for example, averaging 30 micrometers or less in diameter) and carried to a collector where the fibers collect as a coherent entangled web. The foregoing webs may be self-sustaining in form, or they may be looser and only made self-sustaining during a web-densification step such as, for example, calendering, hot can, or through-air bonding.

Different materials such as fibers of different materials may be combined so as to prepare a blended nonwoven web. For example, staple fibers may be blended into meltblown fibers in the manner taught in U.S. Pat. No. 4,118,531 (Hauser); or particulate material may be introduced and captured within a web in the manner taught in U.S. Pat. No. 3,971,373 (Braun); or microwebs as taught in U.S. Pat. No. 4,813,948 (Insley) may be blended into a web. Webs that are a blend of thermoplastic fibers and other fibers such as wood pulp fibers may also be used, though introduction of non-thermoplastic material is generally less desirable as it tends to reduce thermal processibility of the nonwoven web.

If desired, the porous facing material may further comprise various additives (for example, as melt additives to the elastomer before fiber formation or as an additive treatment to the fibers once formed) such as for example, flame retardants, and stabilizers (for example, ultraviolet light absorbers, antioxidants, and/or hindered amine light stabilizers).

Typically, nonwoven webs useful in practice of the present invention have a single unitary layer; however, they may have more than one layer.

Porous facing materials according to and/or used in practice of the present invention are typically prepared by smoothing a thicker precursor nonwoven material (for example, a spunbond or a meltblown nonwoven material) under heat and/or pressure, however, this is not a requirement. Well-known calendering procedures are suitable for such smoothing. Usually the rolls of the calender (for example, metal rolls, high durometer rubber rolls, or a combination thereof) are smooth surfaced, but rolls carrying relief projections and/or recesses can be used; for example, to achieve point bonding of the nonwoven web and/or to impart a predetermined texture to at least a portion of a calendered surface of the porous facing material. If desired, calender rolls may be selected such that, after calendering, one of the first or second major surfaces is smoother (for example, substantially smoother) than the other.

Sufficient heat and pressure are used to compact the nonwoven material, but heating conditions that would cause sheet material to flow so as to fall below an appropriate level of porosity (for example, by plugging surface pores) should generally be avoided. Stretching or heating of a sheet may be used to re-open overly closed openings or to enlarge overly narrow openings.

The fibers of the nonwoven web may have any size, but typically the fibers have a mean fiber diameter of less than about 100 micrometers, more typically less than about 50 micrometers, and more typically in a range of from about 10 to about 30 micrometers. Such fine fiber sizes tend to lead to desirable combinations of properties such as feel, appearance, hand, and the like.

Porous facing materials according to and/or useful in practice of the present invention typically have a basis weight in a range of from 100 to 1500 grams per square meter (gsm), although higher basis weights may also be used. For example, the nonwoven web may have a basis weight in a range of from 100 gsm, from 200 gsm, from greater than 250 gsm, or from greater than 300 gsm up to 500 gsm, 750 gsm, 1000, 1250, or even 1500 gsm. The specific choice of basis will typically be influenced by the intended use and cost.

Porous facing materials according to and/or useful in practice of the present invention typically have a thickness after any optional densification and/or surface texturing (for example, smoothing or imparting of features) in a range of from 0.2 to 3.5 millimeters. For example, the nonwoven web may have a thickness in a range of from 0.2, 0.25, 0.3, 0.4, or 0.5 millimeters up to 0.75, 1, 1.5, 2, 2.5, 3, or 3.5 millimeters.

Advantageously, porous facing materials according to and/or useful in practice of the present invention have a degree of durability. For example, they generally have at least one major surface (typically a calendered surface, but this is not required) that can pass at least 30, 100, 200, 400, 200, 4000, 10000, 25000, or even at least 50000 wear cycles of the Taber Abrasion Test described herein. Of course, greater abrasion resistance will be preferred for applications in which significant opportunity for abrasion (for example, seats, door panels, and arm rests) is present. Lesser abrasion resistance is suitable for those applications not likely to see any significant abrasion (for example, headliners in vehicle interiors).

If high strength is desired, porous facing materials having significant strength may be readily fabricated and used; for example, as described herein. For example, the porous facing material may have a cross-web breaking force per one inch (2.54 cm) width of facing material of at least 5, 50, 100, 200, 250, 400, or even at least 500 newtons and a corresponding elongation at break of at least 150, 200, or 250 percent.

If desired, the porous facing material may be converted to a form suited to a specific application. For example, it may be die cut (including the introduction of cutouts) to a specific shape, perforated, embossed, and/or shaped.

Advantageously, if desired, the porous facing material may be thermoformed, for example, using methods well known in the art. Thermoforming refers to the process of heating the porous facing material and urging it against the surface of a mold (for example, pulling it down under vacuum) to shape it. Useful thermoforming methods include vacuum forming, pressure forming, twin-sheet forming, drape forming, free blowing, and simple sheet bending. Thermoforming may be carried out using the porous facing material alone or in combination with a backing (for example, a porous or non-porous backing and/or a nonporous removable liner). If desired, the thermoformed porous facing material may be back-filled (for example, by injection molding) with a solid polymer or an open or closed cell polymeric foam (for example, an open or closed cell polyurethane foam).

The porous facing material is, of course, porous (including macroporous and microporous), which allows a degree of moisture vapor transport, and functionality if used in an acoustically attenuating composite. For use in an acoustically attenuating composite, the porosity of the porous facing material is typically sufficient to produce an airflow resistance between the first and second major surfaces of the porous facing material; for example, the airflow resistance may be in a range of from of from 100 to 10000 mks rayls, more typically in a range of from of from 200 to 3000 mks rayls, and more typically in a range of from 300 to 2500 mks rayls.

Typically, the porous facing material has a solidity in a range of from 0.15 to 0.60, although values outside this range may also be used. Solidity is a dimensionless quantity representing the fraction of solid content in a given specimen. Solidity can be determined by: (a) dividing the specimen basis weight by the specimen thickness to determine the specimen bulk density; and then (b) dividing the specimen bulk density by the density of the material making up the specimen. For higher abrasion resistance, the solidity of the porous facing material is desirably at least about 0.35, 0.50 or at least about 0.55.

The porous facing material is desirably of sufficient porosity to provide at least a degree of breathability, or MVTR (Moisture Vapor Transmission) value for comfort when the material is used at a human interface; for example, in some embodiments, the porous facing material has a rate of moisture vapor transmission according to ASTM E96/E96M-05, “Standard Test Methods for Water Vapor Transmission of Materials” (2005), using the Procedure for Water Method (upright dish) of at least 600, 700, 800, 900, or even at least 1000 grams per square meter per 24 hours (g/m²/24 hr).

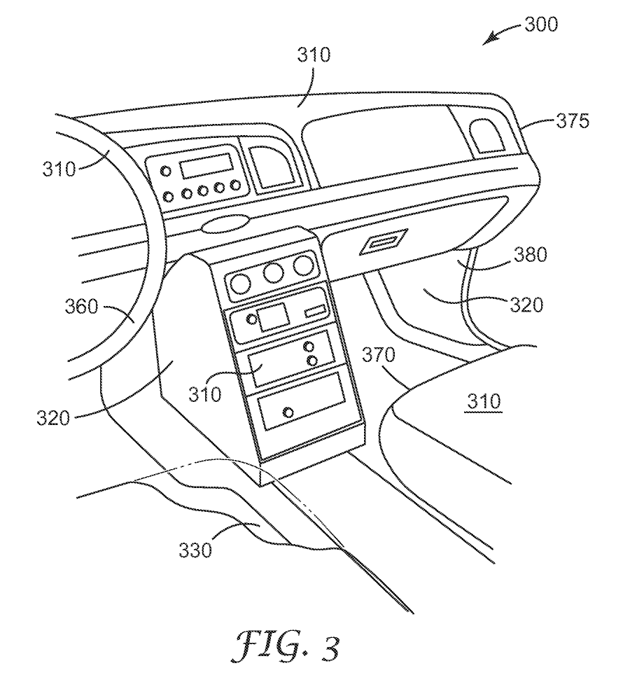

Porous facing material is useful, for example, in fabrication of acoustically attenuating composites. Referring now to FIG. 2, acoustically attenuating composite 200 comprises porous facing material 205. Porous facing material 205 may or may not be the same as porous facing material 100 shown in FIG. 1. Porous facing material 205 has first and second opposed major surfaces 210, 212 and comprises nonwoven web 220, which may or may not be the same as porous facing material 100 shown in FIG. 1. Nonwoven web 220 comprises interfused thermoplastic elastomeric fibers 230. Porous backing 250 is secured to second major surface 212 of porous facing material 205, in some embodiments it is secured by optional adhesive layer 260. Acoustically attenuating composite 200 is sufficiently porous that it has an airflow resistance in a range of from 100 to 10000 mks rayls.

The porous backing provides an air space that facilitates acoustic attenuation. Accordingly, it should be permeable to air. Exemplary porous backings suitable for use in fabrication of acoustically attenuating composites include: nonwoven materials (for example, lightly compacted or non-compacted nonwoven webs); open cell foams; and shoddy. The thickness of the porous backing is not critical, but since the frequency of sound that is attenuated is inversely proportional to the thickness of the air space, the thickness of the porous backing is typically at least about 1, 2, 3, 4, 5, 6, 7, 8, 9, or 10 millimeters or more.

The porous backing and the porous facing material are secured to one another. Any effective method may be used; for example, glue, adhesives (for example, pressure-sensitive and/or hot melt adhesives), welding (for example, spot or point welding), heat lamination, rivets or other mechanical fasteners, and combinations thereof.

Porous facing material and/or acoustically attenuating composites according to the present invention have a wide range of uses. For example, they may be used as motor vehicle (for example, cars, trucks, buses, motorboats, airplanes, or trains) interior components comprising an A- or B-surface. Examples include door panels, head rests, arm rests, dashboards, headliners, seats, floor coverings, rear window decks, steering wheels, visors, pillar surfaces, consoles, trunk liners, and combinations thereof. Porous facing material and/or acoustically attenuating composites are also suited for use as: upholstery (for example, for furniture and/or vehicle or boat seats); architectural coverings such as wall or ceiling coverings.

FIG. 3 shows a perspective cutaway view of an example automobile interior 300 showing A-surfaces 310, B-surfaces 320, and C-surface 330. Porous facing material 100 covers steering wheel 360, and acoustically attenuating composite 200 is used for seat 370, dash 375 (wherein it is thermoformed), and interior panel 380.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the Examples and the rest of the specification are by weight.

### Test Methods

The following test methods were used in the examples below.

Basis weight in grams per square meter was determined using a 5.25-inch (0.133-meter) diameter specimen.

Thickness was determined using a 12-inch (30-cm)×12-inch (30-cm) foot applying a pressure of 130 g to a 5.25-inch (0.133-meter) diameter specimen, thereby applying a pressure to the specimen on 0.013 psi (90 Pa).

Cross-web breaking force and elongation at break were determined generally according to procedures (with changes noted below) of ASTM D 5035-06, “Standard Test Method for Breaking Force and Elongation of Textile Fabrics (Strip Method)” (2006) using a force measurement device available under the trade designation “INSTRON TENSILE TESTER, MODEL 5544” from Instron Corp., Norwood, Mass. The specimen type was identified in section 4.2.1.3 of the standard as Type 1C-25 mm (1.0 in.) cut strip test. The type of force measurement device is identified in section 4.2.2.1 of the standard as Type E-constant-rate-of-extension (CRE.) The gage length used was 5 inches (12.7 cm). The rate of extension (crosshead speed) used was 10 inches per minute. Jaw size was 2 inches (5 cm) by 1 inch (2.5 cm). The specimen was extended to the breaking point and results are reported as the breaking force and percent elongation at break.

Taber Abrasion Resistance: The Taber abrasion resistance of the material was evaluated according to the Taber Abrasion Test described hereinabove.

Airflow Resistance: Airflow resistance was measured according to ASTM C 522-03, “Standard Test Method for Airflow Resistance of Acoustical Materials” (2003).

Fiber Diameter was measured using an optical microscope.

Solidity was determined by dividing the specimen basis weight (in grams/meter²) by the specimen thickness (in millimeters) then dividing this quotient (that is, the specimen bulk density) by the product of the density of the material making up the specimen (in g/cm³) multiplied by a constant of 1000 to normalize the units of measure.

MVTR values were determined according to ASTM E96/E96M-05, “Standard Test Methods for Water Vapor Transmission of Materials” (2005), using the Procedure for Water Method (upright dish).

### Examples 1a to 5c

A polyurethane mixture of equal parts of a first thermoplastic aromatic polyurethane elastomer having a tensile modulus of 14 megapascals at 300 percent elongation and density of 1.21 g/cm³ (available under the trade designation “IROGRAN PS440-200” from Huntsman International, Salt Lake City, Utah), and a second thermoplastic aromatic polyurethane elastomer having a tensile modulus of 24 megapascals at 300 percent elongation and density of 1.21 g/cm³ (available under the trade designation “IROGRAN PS443-201” from Huntsman International), and dried at 180° F. (82.2° C.) for more than 6 hours. A black colorant (available under the trade designation “CLARIANT BLACK PIGMENT CONCENTRATE”, product code 00036847, from Clariant Corp., Charlotte, N.C.) was dried at 180° F. (82.2° C.) for more than 4 hours. Once dry, 96 parts of the polyurethane mixture and 4 parts of the black colorant were horizontally extruded through an extrusion die having a row of orifices with an orifice size of 0.015 inch (0.038 cm) diameter, spaced apart at a distance of 0.040 inch (0.10 cm), and operating at a rate of 0.08 lb/hole/hr (0.36 kg/hole/hr). High velocity air (air pressure set to 4.5 psi (31 kPa)) was blown through air knives on each side of the extrudate substantially parallel to the direction of extrusion. The die temperature was 230° C. and the air temperature was 270° C. The resultant fibers were collected on a rotating collector located at a distance of 5.5 inches (14 cm) from the die orifices to form a meltblown nonwoven web. The meltblown web was then removed from the collector and calendered between a smooth steel roll heated at 220° F. (104° C.) and a smooth rubber roll heated at 150° F. (65.5° C.), and then wound onto a roll. Pneumatic cylinders were used to adjust the maximum pressure at the nip to 462 pounds/lineal inch (82.5 kg/lineal cm) at a minimum nip gap setting of 0.006 inches (0.15 mm). The basis weight, thickness, and test results of the meltblown webs corresponding to Examples 1a to 5c are reported in Table 1 (below).

TABLE 1

| | | | | | | Cross-web | |
|---|---|---|---|---|---|---|---|
| | | | | | | Breaking | |
| | | | | | | Force of 1- | |
| | | | | | TABER | inch (2.54 cm) | Cross-web |
| | BASIS | | | FIBER | ABRASION | width | Percent |
| | WEIGHT, | THICKNESS, | | DIAMETER, | TEST, | specimen, | Elongation |
| EXAMPLE | gsm | mm | SOLIDITY | micrometers | cycles to failure | newtons | at Break |
| 1a | 202 | 0.45 | 0.37 | 13 | >250 and <500 | 64.4 | 292 |
| 1b | 200 | 0.44 | 0.38 | 12 | >500 and <600 | 55.7 | 291 |
| 1c | 203 | 0.45 | 0.37 | 12 | >250 and <500 | 65.9 | 296 |
| 2a | 287 | 0.55 | 0.43 | 16 | >4000 and <4315 | 98.5 | 372 |
| 2b | 286 | 0.53 | 0.45 | 15 | >4500 and <4900 | 102.8 | 331 |
| 2c | 300 | 0.54 | 0.46 | 16 | >4315 and <4500 | 104.1 | 312 |
| 3a | 380 | 0.75 | 0.42 | 11 | >12500 and <12800 | 159.1 | 316 |
| 3b | 379 | 0.66 | 0.48 | 15 | >10000 and 11110 | 157.2 | 322 |
| 3c | 419 | 0.60 | 0.58 | 13 | >11110 and <12500 | 149.6 | 395 |
| 4a | 479 | 0.86 | 0.46 | 15 | >15000 and <17200 | 206.2 | 359 |
| 4b | 483 | 0.75 | 0.53 | 14 | >25000 and <26500 | 186.4 | 337 |
| 4c | 525 | 0.75 | 0.58 | 12 | >17500 and <18350 | 209.5 | 358 |
| 5a | 607 | 0.84 | 0.60 | 11 | >45000 and <50000 | 226.3 | 353 |
| 5b | 620 | 0.96 | 0.53 | 13 | >80000 and <90000 | 251.6 | 369 |
| 5c | 634 | 0.92 | 0.57 | 12 | >56000 and <70000 | 229.0 | 348 |

Acoustic absorption testing of Examples 1a to 5c according to ASTM E 1050-98, “Standard Test Method for Impedance and Absorption of Acoustical Materials Using a Tube, Two Microphones and a Digital Frequency Analysis System” (Reapproved 2006) was performed. Results are reported in Table 2 (below), which also includes airflow resistance and moisture vapor transmission rate (MVTR) properties according to ASTM E96/E96M-05, “Standard Test Methods for Water Vapor Transmission of Materials” (2005), using the Procedure for Water Method (upright dish).

TABLE 2

| | | | ACOUSTIC ABSORPTION - | ACOUSTIC ABSORPTION - |
|---|---|---|---|---|
| | | | ⅓ Octave Band Avg. | ⅓ Octave Band Avg. |
| | MVTR, | AIRFLOW | 100 - 6300 Hz. - Small | 100 - 6300 Hz. - Small |
| | grams per square | RESISTANCE, | Tube - Over 24 mm | Tube - Over 24 mm |
| EXAMPLE | meter per day | mks rayls | Calibration Foam | Air Gap |
| 1a | 1263 | 460 | 0.48 | 0.43 |
| 1b | 1237 | 478 | 0.47 | 0.40 |
| 1c | 1372 | 478 | 0.48 | 0.43 |
| 2a | 1247 | 1122 | 0.47 | 0.44 |
| 2b | 1214 | 1196 | 0.47 | 0.44 |
| 2c | 1276 | 920 | 0.48 | 0.43 |
| 3a | 1112 | 1655 | 0.40 | 0.39 |
| 3b | 1210 | 2299 | 0.43 | 0.41 |
| 3c | 1056 | 1380 | 0.42 | 0.40 |
| 4a | 1092 | 2906 | 0.40 | 0.39 |
| 4b | 937 | 3550 | 0.31 | 0.30 |
| 4c | 1161 | 4893 | 0.42 | 0.41 |
| 5a | 977 | 4635 | 0.25 | 0.23 |
| 5b | 997 | 4543 | 0.24 | 0.24 |
| 5c | 1033 | 3072 | 0.33 | 0.32 |

### Examples 6a to 11c

In Examples 6-9, an aromatic polyurethane thermoplastic elastomer having a tensile modulus of 14 megapascals at 300 percent elongation and density of 1.21 g/cm³ (available under the trade designation “IROGRAN PS440-200” from Huntsman International, Salt Lake City, Utah) and dried at 180° F. (82.2° C.) overnight. Once dry, the polyurethane was horizontally extruded through an extrusion die having a row of orifices with an orifice size of 0.015 inch (0.038 cm) diameter, spaced apart at a distance of 0.040 inch (0.10 cm), and operating at a rate of 0.035 lb/hole/hr (0.016 kg/hole/hr). High velocity air (air pressure set to 4.5 psi (31 kPa)) was blown through air knives on each side of the extrudate substantially parallel to the direction of extrusion. The die temperature was 225° C. and the air temperature was 204° C.

In Examples 10-11, a metallocene polymerized polyolefin thermoplastic elastomer having a Melt Flow Rate (MFR) of 80 grams/10 minutes (based on ASTM D-1238 (230° C. and 2.16 kg)) and density of 0.865 g/cm³ (available under the trade designation “VISTAMAXX VM2125” from ExxonMobil Chemical Corp., Irving, Tex.) was horizontally extruded using a die with an orifice size of 0.015 inch (0.038 cm) diameter, spaced apart at a distance of 0.040 inch (0.10 cm), at a rate of 0.040 lb/hole/hr (0.018 kg/hole/hr). High velocity air (air pressure set to 5.5 psi (38 kPa)) was blown through air knives on each side of the extrudate substantially parallel to the direction of extrusion. The die temperature was 275° C. and the air temperature was 260° C.

The resultant fibers were collected on a rotating collector located at a distance from the die orifices as noted below to form a meltblown nonwoven web. The meltblown web was then removed from the collector and wound on a roll. The web was then calendered between two smooth steel rolls heated to the temperatures reported in Table 3 (below).

TABLE 3

| | | CALENDER | CALENDER ROLL |
|---|---|---|---|
| | COLLECTOR | PRESSURE, | TEMPERATURES - |
| EXAM- | DISTANCE, | pounds/lineal inch | UPPER ° F./LOWER ° F., |
| PLE | inches (cm) | (kg/lineal cm) | (UPPER ° C./LOWER° C.) |
| 6a-c | 12 (30) | 214 (97.1) | 250/75 (121/24) |
| 7a-c | 15 (38) | 214 (97.1) | 250/75 (121/24) |
| 8a-c | 20 (51) | 214 (97.1) | 250/75 (121/24) |
| 9a-c | 20 (51) | 214 (97.1) | 250/75 (121/24) |
| 10a-c | 30 (76) | 683 (310) | 150/75 (65.6/24) |
| 11a-c | 30 (76) | 214 (97.1) | 170/75 (76.7/24) |

The basis weight, thickness, and test results of the meltblown webs corresponding to Examples 6 to 11 are reported in Table 4 (below).

TABLE 4

| | | | | | | Cross-web | |
|---|---|---|---|---|---|---|---|
| | | | | | | Breaking | |
| | | | | | | Force of 1- | |
| | | | | | TABER | inch (2.54 cm) | Cross-web |
| | BASIS | | | FIBER | ABRASION | width | Percent |
| | WEIGHT, | THICKNESS, | | DIAMETER, | TEST, | specimen, | Elongation |
| EXAMPLE | gsm | mm | SOLIDITY | micrometers | cycles to failure | newtons | at Break |
| 6a | 119 | 0.26 | 0.38 | 12 | >200 and <250 | 23.3 | 350 |
| 6b | 105 | 0.24 | 0.36 | 15 | >200 and <250 | 20.1 | 331 |
| 6c | 108 | 0.24 | 0.37 | 13 | >200 and <250 | 21.3 | 297 |
| 7a | 288 | 0.90 | 0.26 | 13 | >700 and <750 | 53.4 | 370 |
| 7b | 247 | 0.73 | 0.28 | 14 | >700 and <750 | 56.5 | 358 |
| 7c | 257 | 0.85 | 0.25 | 12 | >700 and <750 | 60.5 | 413 |
| 8a | 746 | 2.81 | 0.22 | 14 | >800 and <850 | 149.7 | 377 |
| 8b | 720 | 2.66 | 0.22 | 13 | >800 and <850 | 145.9 | 377 |
| 8c | 615 | 2.50 | 0.20 | 15 | >800 and <850 | 135.7 | 446 |
| 9a | 470 | 1.64 | 0.24 | 12 | >750 and <800 | 92.1 | 425 |
| 9b | 458 | 1.64 | 0.23 | 14 | >750 and <800 | 86.8 | 453 |
| 9c | 409 | 1.37 | 0.25 | 13 | >750 and <800 | 89.8 | 408 |
| 10a | 399 | 1.85 | 0.25 | 17 | >40 and <50 | 17.7 | 419 |
| 10b | 430 | 2.07 | 0.24 | 14 | >40 and <50 | 17.6 | 396 |
| 10c | 428 | 2.01 | 0.25 | 15 | >40 and <50 | 20.7 | 322 |
| 11a | 270 | 0.98 | 0.32 | 16 | >40 and <50 | 14.3 | 394 |
| 11b | 300 | 1.05 | 0.33 | 16 | >40 and <50 | 15.0 | 323 |
| 11c | 276 | 0.99 | 0.32 | 15 | >30 and <40 | 12.5 | 357 |

Acoustic absorption testing of Examples 6a to 11c according to ASTM E 1050-98, “Standard Test Method for Impedance and Absorption of Acoustical Materials Using a Tube, Two Microphones and A Digital Frequency Analysis System” (Reapproved 2006) was performed. Results are reported in Table 5 (below), which also includes airflow resistance and moisture vapor transmission rate (MVTR) properties according to according to ASTM E96/E96M-05, “Standard Test Methods for Water Vapor Transmission of Materials” (2005), using the Procedure for Water Method (upright dish).

TABLE 5

| | | | ACOUSTIC ABSORPTION - | ACOUSTIC ABSORPTION - |
|---|---|---|---|---|
| | | | ⅓ Octave Band Avg. | ⅓ Octave Band Avg. |
| | MVTR, | AIRFLOW | 100 - 6300 Hz. - Small | 100 - 6300 Hz. - Small |
| | grams per square | RESISTANCE, | Tube - Over 24 mm | Tube - Over 24 mm |
| EXAMPLE | meter per day | mks rayls | Calibration Foam | Air Gap |
| 6a | 1299 | 533 | 0.49 | 0.44 |
| 6b | 1365 | 497 | 0.50 | 0.45 |
| 6c | 1280 | 460 | 0.50 | 0.44 |
| 7a | 1214 | 4488 | 0.39 | 0.35 |
| 7b | 1214 | 3035 | 0.46 | 0.42 |
| 7c | 1227 | 3292 | 0.42 | 0.39 |
| 8a | 937 | 25236 | 0.26 | 0.21 |
| 8b | 822 | 23452 | 0.20 | 0.19 |
| 8c | 1053 | 22532 | 0.20 | 0.20 |
| 9a | 1138 | 22569 | 0.21 | 0.20 |
| 9b | 1184 | 16702 | 0.34 | 0.33 |
| 9c | 1085 | 13188 | 0.34 | 0.31 |
| 10a | 1115 | 736 | 0.51 | 0.46 |
| 10b | 1214 | 681 | 0.51 | 0.40 |
| 10c | 1148 | 699 | 0.51 | 0.47 |
| 11a | 1280 | 2612 | 0.42 | 0.40 |
| 11b | 1040 | 3109 | 0.47 | 0.45 |
| 11c | 1129 | 3384 | 0.44 | 0.40 |

### Examples 12a to 18c

In Examples 12a-18c, an apparatus as shown in FIGS. 1-3 in U.S. Pat. Appln. Publ. 2005/0106982 A1 (Berrigan et al.) was used to prepare the fibrous webs. In Examples 12a-18c the extrusion head (that is, die) had two pools (that is, sections). Each pool area had 9 rows of holes with 36 holes per row, making a total of 648 orifices. Each pool area was 9 25/32 inches (250 mm) by 1.75 inches (44.5 mm) The holes were on 0.25 inch (6.4 mm) centers, and the rows were offset by 0.25 inches (6.4 mm). There was a space between the sets of rows of holes of 0.625 inches (15.9 mm) and a space between the sets of pools of 0.625 inches (15.9 mm). The hole diameter was 0.020 inch (0.445 mm) and the length/diameter ratio was 6.

Referring now to FIG. 1 of U.S. Pat. Appln. Publ. 2005/0106982 A1 (Berrigan et al.), the distance between the die and attenuator (dimension 17) was 37 inches (94 cm), and the distance from the attenuator to the collector (dimension 21) was 26.75 inches (68 cm).

Referring now to FIG. 2 of U.S. Pat. Appln. Publ. 2005/0106982 A1 (Berrigan et al.), the air knife gap (the dimension 30) was 0.030 inch (0.76 mm), the attenuator body angle (alpha) was 30 degrees, room temperature air was passed through the attenuator, and the length of the attenuator chute (dimension 35) was 6 inches (152 mm). The attenuator body 28, in which the recess for the air knife 32 was formed, had a transverse length of 330 mm, and the transverse length of the wall 36 attached to the attenuator body was 14 inches (406 mm).

Referring now to FIG. 3 of U.S. Pat. Appln. Publ. 2005/0106982 A1 (Berrigan et al.), the air knife had a transverse length (the direction of the length 25 of the slot) of 251 mm.

The total volume of air passed through the attenuator (given in actual cubic meters per minute, or ACMM was 140; about half of the listed volume was passed through each air knife 32). Clamping pressure on the walls of the attenuator was 500-550 kilopascals, which tended to hold the walls against movement during the process. The webs were subjected to annealing by passing them under a hot air knife set at 95° C. for an exposure time of 0.11 second with a face velocity of 21 meters per second with a slot width (the machine-direction dimension) of 1.5 inches (3.8 centimeters).

In Examples 12a-14c, a metallocene polymerized polyolefin thermoplastic elastomer having a Melt Flow Rate (MFR) of 80 grams/10 minutes (based on ASTM D-1238 (230° C. and 2.16 kg)) and density of 0.865 g/cm³ (available under the trade designation “VISTAMAXX VM2125” from ExxonMobil Chemical Co., Houston, Tex. was extruded as described above. The die was heated to a temperature of 220° C. Throughput rate was 0.074 lbs/hole/hr (0.034 kg/hole/hr).

In Examples 15a-18c, an aromatic polyurethane thermoplastic elastomer having a tensile modulus of 14 megapascals at 300 percent elongation and density of 1.21 g/cm³ (available under the trade designation “IROGRAN PS440-200” from Huntsman International, Salt Lake City, Utah) was dried at 180° F. (82.2° C.) overnight prior to being extruded as described above. The die was heated to a temperature of 225° C. Throughput rate was 0.071 lbs/hole/hr (0.032 kg/hole/hr).

The resultant fiber webs were then wound onto respective rolls and then calendered between two smooth steel rolls heated to the temperatures reported in Table 6 (below).

TABLE 6

| | CALENDER | CALENDER ROLL |
|---|---|---|
| | PRESSURE, | TEMPERATURES - |
| | pounds/lineal inch | UPPER ° F./LOWER ° F., |
| EXAMPLES | (kg/lineal cm) | (UPPER ° C./LOWER ° C.) |
| 12a-12c | 393 (178) | 100/70 (37.8/21) |
| 13a-13c | 393 (178) | 135/70 (57.2/21) |
| 14a-14c | 393 (178) | 160/70 (71.1/21) |
| 15a-15c | 654 (297) | 295/150 (146/65.6) |
| 16a-16c | 654 (297) | 295/150 (146/65.6) |
| 17a-17c | 654 (297) | 295/150 (146/65.6) |
| 18a-18c | 654 (297) | 295/150 (146/65.6) |

The basis weight, thickness, and test results of the meltblown webs corresponding to Examples 12a to 18c are reported in Table 7 (below).

TABLE 7

| | | | | | | Cross-web | |
|---|---|---|---|---|---|---|---|
| | | | | | | Breaking | |
| | | | | | TABER | Force of 1- | |
| | | | | | ABRASION | inch (2.54 cm) | Cross-web |
| | BASIS | | | FIBER | TEST, | width | Percent |
| | WEIGHT, | THICKNESS, | | DIAMETER, | cycles to | specimen, | Elongation at |
| EXAMPLE | gsm | mm | SOLIDITY | micrometers | failure | newtons | Break |
| 12a | 209 | 1.47 | 0.16 | 19 | >70 and <75 | 5.9 | 329 |
| 12b | 205 | 1.33 | 0.18 | 20 | >70 and <75 | 8.2 | 351 |
| 12c | 205 | 1.95 | 0.12 | 20 | >70 and <75 | 7.6 | 472 |
| 13a | 436 | 1.79 | 0.28 | 24 | >90 and <100 | 23.6 | 439 |
| 13b | 430 | 1.63 | 0.30 | 23 | >90 and <100 | 17.4 | 366 |
| 13c | 431 | 1.64 | 0.30 | 23 | >90 and <100 | 19.8 | 361 |
| 14a | 649 | 2.24 | 0.34 | 22 | >350 and <400 | 33.2 | 407 |
| 14b | 633 | 2.03 | 0.36 | 22 | >350 and <400 | 26.9 | 215 |
| 14c | 650 | 2.16 | 0.35 | 22 | >350 and <400 | 37.0 | 409 |
| 15a | 131 | 0.53 | 0.20 | 22 | >80 and <90 | 23.3 | 205 |
| 15b | 133 | 0.62 | 0.18 | 20 | >80 and <90 | 30.3 | 192 |
| 15c | 133 | 0.63 | 0.17 | 21 | >80 and <90 | 21.3 | 181 |
| 16a | 250 | 1.22 | 0.17 | 22 | >135 and <150 | 47.5 | 215 |
| 16b | 233 | 1.17 | 0.16 | 24 | >150 and <175 | 40.8 | 214 |
| 16c | 238 | 1.10 | 0.18 | 24 | >135 and <150 | 58.7 | 237 |
| 17a | 431 | 2.20 | 0.16 | 24 | >450 and <500 | 73.5 | 204 |
| 17b | 460 | 2.32 | 0.16 | 22 | >175 and <200 | 96.5 | 226 |
| 17c | 420 | 2.17 | 0.16 | 24 | >175 and <200 | 73.3 | 216 |
| 18a | 650 | 3.29 | 0.16 | 23 | >450 and <500 | 89.8 | 222 |
| 18b | 687 | 3.28 | 0.17 | 25 | >350 and <400 | 146.0 | 262 |
| 18c | 704 | 3.50 | 0.17 | 26 | >500 and <600 | 112.8 | 255 |

Acoustic absorption testing of Examples 12a to 18c according to ASTM E 1050-98, “Standard Test Method for Impedance and Absorption of Acoustical Materials using a Tube, Two Microphones and a Digital Frequency Analysis System” (Reapproved 2006) was performed. Results are reported in Table 2 (below), which also includes measured airflow resistance and moisture vapor transmission rate (MVTR) properties according to according to ASTM E96/E96M-05, “Standard Test Methods for Water Vapor Transmission of Materials” (2005), using the Procedure for Water Method (upright dish).

TABLE 8

| | | | Acoustic Absorption - | Acoustic Absorption - |
|---|---|---|---|---|
| | | | ⅓ Octave Band Avg. | ⅓ Octave Band Avg. |
| | MVTR, | AIRFLOW | 100 - 6300 Hz. - Small | 100 - 6300 Hz. - Small |
| | grams per square | RESISTANCE, | Tube - Over 24 mm | Tube - Over 24 mm |
| EXAMPLE | meter per day | mks rayls | Calibration Foam | Air Gap |
| 12a | 1452 | 147 | 0.42 | 0.31 |
| 12b | 1723 | 166 | 0.42 | 0.31 |
| 12c | 1476 | 147 | 0.43 | 0.30 |
| 13a | 1167 | 570 | 0.52 | 0.47 |
| 13b | 1321 | 533 | 0.50 | 0.42 |
| 13c | 1236 | 570 | 0.51 | 0.44 |
| 14a | 185 | 8903 | 0.50 | 0.46 |
| 14b | 316 | 11367 | 0.50 | 0.47 |
| 14c | 2112 | 11514 | 0.50 | 0.45 |
| 15a | 1727 | 55 | 0.17 | 0.15 |
| 15b | 1802 | 55 | 0.19 | 0.17 |
| 15c | 2197 | 55 | 0.18 | 0.16 |
| 16a | 1421 | 129 | 0.35 | 0.17 |
| 16b | 1345 | 129 | 0.33 | 0.14 |
| 16c | 1470 | 147 | 0.35 | 0.16 |
| 17a | 1270 | 221 | 0.45 | 0.36 |
| 17b | 1263 | 258 | 0.41 | 0.24 |
| 17c | 1204 | 221 | 0.47 | 0.35 |
| 18a | 1227 | 276 | 0.48 | 0.39 |
| 18b | 1135 | 331 | 0.52 | 0.45 |
| 18c | 1125 | 331 | 0.50 | 0.44 |

### Example 19

Material made according to the procedure of Example 3c was molded into a three-dimensional shape using pressure/vacuum thermoforming. A 13.5 inches (34.3 cm) by 15 inches (38.1 cm) specimen of the material was adhered to a nonporous tape available under the trade designation “SCOTCH BRAND ADHESIVE TAPE 331TB” available from the 3M Company, St. Paul, Minn., and was placed in the rectangular clamping frame of a thermoformer obtained from the Hydro-Trim Corporation of W. Nyack, N.Y. under the trade designation “LABFORM MODEL 2024PV”. The open area between the inside edges of the clamping frame was 9 inches (22.9 cm) by 11 inches (27.9 cm). The frame was then advanced into a thermoforming oven. The temperature in the thermoforming oven was set at 400° F. (204° C.) and oven residence time was 45 seconds. Upon exiting the oven, the now heated material was immediately stretched over a semi-hemispherical porous mold with a diameter of 3.75 inches (9.53 cm) and a height of 2.25 inches, drawing the material to 153 percent of its original size in the three-dimensional molded region. There was a positive pressure of 105 psi (724 kPa) placed on the top (temporary film) face of the part and a negative pressure (vacuum) of 0.53 psi (3.7 kPa) pulled against the opposite face of the material through the mold. Mold residence time was 10 seconds. Upon removal of the part from the mold, it was released from the clamping frame and the temporary film backer was removed. The part had formed to and retained the three-dimensional shape of the mold without tearing, wrinkling or changes to the visual, texture or aesthetic feel of the material. Drawing of the material was spread out throughout the entire dimension of the part and not isolated to the area of high extension so there was no tearing or isolated thinning of the thermoformed part in any one area as is typically found with non-elastomeric materials. Thickness readings of the web were obtained before and after thermoforming using a electronic calipers (model IP65, obtained from Brown & Sharpe, North Kingstown, R.I.). Results are reported in Table 9 (below).

TABLE 9

| THICKNESS | THICKNESS AFTER | THICKNESS AFTER |
|---|---|---|
| BEFORE | THERMOFORMING | THERMOFORMING |
| THERMO- | IN AREA OUTSIDE THE | IN AREA OF THE |
| FORMING, mm | 3-D FORMATION, mm | 3-D FORMATION, mm |
| 0.60, 0.61, 0.61, | 0.56, 0.55, 0.54, | 0.46, 0.52, 0.51, 0.57, |
| 0.61, 0.59, 0.61 | 0.50, 0.56, 0.55 | 0.51, 0.54, 0.47 |

### Example 20

Specimens of the material made according to the procedure of Examples 10a-c, and having basis weights a indicated in Table 10 were separately laminated to a fibrous insulation available under the trade designation “THINSULATE ACOUSTIC INSULATION TAI 2027” using a spray pressure sensitive adhesive available under the trade designation “3M SPRAY 77 ADHESIVE”, both available from 3M Company, St. Paul, Minn. The weight and airflow resistance of the individual components and the laminated composite were measured with results reported in Table 10 (below).

TABLE 10

| | MATERIAL | | | | | |
|---|---|---|---|---|---|---|
| | PREPARED AS | | | | | |
| | IN EXAMPLES 10a-c | | FIBROUS INSULATION | | LAMINATE | |
| | BASIS | AIRFLOW | BASIS | AIRFLOW | BASIS | AIRFLOW |
| | WEIGHT, | RESISTANCE, | WEIGHT, | RESISTANCE, | WEIGHT, | RESISTANCE, |
| Example | gsm | mks rayls | gsm | mks rayls | gsm | mks rayls |
| 19a | 424 | 662 | 224 | 589 | 659 | 1380 |
| 19b | 388 | 607 | 243 | 589 | 640 | 1361 |
| 19c | 392 | 644 | 234 | 607 | 648 | 1361 |

Various modifications and alterations of this invention may be made by those skilled in the art without departing from the scope and spirit of this invention, and it should be understood that this invention is not to be unduly limited to the illustrative embodiments set forth herein.

1. A porous facing material having first and second opposed major surfaces and comprising a nonwoven web, wherein the nonwoven web comprises interfused thermoplastic elastomeric fibers, wherein the interfused thermoplastic elastomeric fibers comprise a blend of at least first and second thermoplastic elastomers, wherein at 300 percent elongation the first thermoplastic elastomer has a first tensile modulus and the second thermoplastic elastomer has a second tensile modulus that is at least 8.2 megapascals greater than the first tensile modulus, wherein the nonwoven web has a basis weight in a range of from 100 to 1500 grams per square meter and a thickness of from 0.2 to 3.5 millimeters, and wherein, if tested, at least one of the first or second surfaces of the porous facing material passes at least 30 wear cycles of the Taber Abrasion Test described herein.

2. The porous facing material of claim 1, wherein, if tested, at least one of the first or second surfaces of the porous facing material passes at least 200 wear cycles of the Taber Abrasion Test described herein.

3. The porous facing material of claim 1, wherein, if tested, at least one of the first or second surfaces of the porous facing material passes at least 4000 wear cycles of the Taber Abrasion Test described herein.

4. The porous facing material of claim 1, wherein, if tested, at least one of the first or second surfaces of the porous facing material passes at least 10000 wear cycles of the Taber Abrasion Test described herein.

5. The porous facing material of claim 1, wherein, if tested, at least one of the first or second surfaces of the porous facing material passes at least 40000 wear cycles of the Taber Abrasion Test described herein.

6. The porous facing material of claim 1, wherein the porous facing material has an airflow resistance in a range of from 100 to 10000 mks rayls.

7. The porous facing material of claim 1, wherein the porous facing material has a cross-web breaking force of at least 50 newtons per one inch (2.54 cm) width and a corresponding elongation at break of at least 150 percent.

8. The porous facing material of claim 1, wherein the porous facing material has a solidity of at least 0.35.

9. The porous facing material of claim 1, wherein the porous facing material has a rate of moisture vapor transmission according to ASTM E96/E96M-05 using the Procedure for Water Method (upright dish) of at least 600 grams per square meter per 24 hours.

10. The porous facing material of claim 1, wherein the nonwoven web is thermoformed.

11. The porous facing material of claim 1, wherein the first and second thermoplastic elastomers are present in a respective weight ratio of from 20:80 to 80:20.

12. The porous facing material of claim 1, wherein the first and second thermoplastic elastomers comprise aliphatic polyurethanes.

13. A method of making an acoustically attenuating composite, the method comprising:
securing the second major surface of the porous facing material of claim 1 to a porous backing such that the acoustically attenuating composite has an airflow resistance in a range of from 100 to 10000 mks rayls.

14. A motor vehicle interior component comprising the porous facing material of claim 1, wherein the first major surface comprises an A-surface or a B-surface.

15. The porous facing material of claim 1 used as upholstery or an architectural covering.

16. An acoustically attenuating composite comprising:
the porous facing material of claim 1; and
a porous backing secured to the second major surface of the porous facing material, wherein the acoustically attenuating composite has an airflow resistance in a range of from 100 to 10000 mks rayls.

17. An acoustically attenuating composite comprising:
a porous facing material having first and second opposed major surfaces and comprising a nonwoven web, wherein the nonwoven web comprises interfused thermoplastic elastomeric fibers, has a basis weight in a range of from greater than 250 to 1500 grams per square meter and has a thickness of from 0.2 to 3.5 millimeters; and
a porous backing secured to the second major surface of the nonwoven web, wherein the acoustically attenuating composite has an airflow resistance of from 100 to 10000 mks rayls.

18. The acoustically attenuating composite of claim 17, wherein, if tested, at least one of the first or second surfaces of the porous facing material passes at least 30 wear cycles of the Taber Abrasion Test described herein.

19. The acoustically attenuating composite of claim 17, wherein the porous facing material has a cross-web breaking force of at least 50 newtons per one inch (2.54 cm) width and a corresponding elongation at break of at least 150 percent.

20. The acoustically attenuating composite of claim 17, wherein the porous facing material has a solidity of at least 0.35.

21. The acoustically attenuating composite of claim 17, wherein the porous facing material has a rate of moisture vapor transmission according to ASTM E96/E96M-05 using the Procedure for Water Method (upright dish) of at least 600 grams per square meter per 24 hours.

22. The acoustically attenuating composite of claim 17, wherein the porous facing material is thermoformed.

23. The acoustically attenuating composite of claim 17, wherein the interfused thermoplastic elastomeric fibers comprise first and second thermoplastic elastomers that are present in a respective weight ratio of from 20:80 to 80:20.

24. The acoustically attenuating composite of claim 23, wherein the first and second thermoplastic elastomers comprise aliphatic polyurethanes.

25. A motor vehicle interior component comprising the acoustically attenuating composite of claim 17, wherein the first major surface comprises an A-surface or a B-surface.

26. The motor vehicle interior component of claim 25, selected from the group consisting of door panels, head rests, arm rests, dashboards, headliners, seats, floor coverings, rear window decks, steering wheels, visors, pillar surfaces, consoles, and trunk liners.

27. The acoustically attenuating composite of claim 17 used as upholstery or an architectural covering.

28. A method of making a porous facing material, the method comprising:
forming fibers of molten thermoplastic elastomeric material wherein the thermoplastic elastomeric material comprises a combination of at least first and second thermoplastic elastomers, wherein at 300 percent elongation the first thermoplastic elastomer has a first tensile modulus and the second thermoplastic elastomer has a second tensile modulus that is at least 8.2 megapascals greater than the first tensile modulus; and
collecting the fibers of molten thermoplastic elastomeric material under conditions such that the fibers of molten thermoplastic elastomeric material interfuse and solidify to form a nonwoven web having first and second major surfaces, a basis weight in a range of from 100 to 1500 grams per square meter, and a thickness of from 0.2 to 3.5 millimeters, and wherein, if tested, at least one of the first or second surfaces of the porous facing material passes at least 30 wear cycles of the Taber Abrasion Test described herein.

29. The method of claim 28, wherein the porous facing material has an airflow resistance in a range of from 100 to 10000 mks rayls.

30. The method of claim 28, wherein the porous facing material has a cross-web breaking force of at least 50 newtons per one inch (2.54 cm) width and a corresponding elongation at break of at least 150 percent.

31. The method of claim 28, wherein the porous facing material has a solidity of at least 0.35.

32. The method of claim 28, wherein the porous facing material has a rate of moisture vapor transmission according to ASTM E96/E96M-05 using the Procedure for Water Method (upright dish) of at least 600 grams per square meter per 24 hours.

33. The method of claim 28, further comprising thermoforming the nonwoven web.

34. The method of claim 28, wherein the first and second thermoplastic elastomers are present in a respective weight ratio of from 20:80 to 80:20.

35. The method of claim 28, wherein the fibers of molten thermoplastic elastomeric material are formed by a meltblown process.

36. A method of making an acoustically attenuating composite, the method comprising:
providing a porous facing material having first and second opposed major surfaces and comprising a nonwoven web of interfused thermoplastic elastomeric fibers and, wherein the porous facing material has a basis weight in a range of from greater than 250 to 1500 grams per square meter and a thickness of from 0.2 to 3.5 millimeters; and
securing the facing material to the porous backing of the second major surface of the nonwoven web such that the acoustically attenuating composite has an airflow resistance of from 100 to 10000 mks rayls.

37. The method of claim 36, wherein, if tested, at least one of the first or second surfaces of the porous facing material passes at least 30 wear cycles of the Taber Abrasion Test described herein.

38. The method of claim 36, wherein the porous facing material has a cross-web breaking force of at least 50 newtons per one inch (2.54 cm) width and a corresponding elongation at break of at least 150 percent.

39. The method of claim 36, wherein the porous facing material has a solidity of at least 0.35.

40. The method of claim 36, wherein the porous facing material has a rate of moisture vapor transmission according to ASTM E96/E96M-05 using the Procedure for Water Method (upright dish) of at least 600 grams per square meter per 24 hours.

41. The method of claim 36, further comprising thermoforming the porous facing material.
